(19) United States
(12) Patent Application Publication
(10) Pub. No.: US 2019/0082693 A1
(43) Pub. Date: Mar. 21, 2019

(54) HERBICIDAL COMPOSITIONS COMPRISING CARFENTRAZONE-ETHYL AND BROMOXYNIL

(71) Applicant: BAYER CROPSCIENCE AKTIENGESELLSCHAFT, Monheim am Rhein (DE)

(72) Inventor: Scott C HENRY, Headingley (CA)

(21) Appl. No.: 16/082,342

(22) PCT Filed: Mar. 1, 2017
(86) PCT No.: PCT/EP2017/054755

§ 371 Date: Sep. 5, 2018

(30) Foreign Application Priority Data
Mar. 8, 2016 (EP) 16159290.2

(51) Int. Cl. A01N 43/653; A01N 37/40; A01N 57/20

(52) U.S. Cl. CPC A01N 43/653; A01N 57/20; A01N 37/40

(57) ABSTRACT

Herbicidal compositions comprising a component A, carfentrazone-ethyl and a component B, mixed heptanoate-octanoate ester of bromoxynil

A description is given of herbicidal compositions comprising a component A, carfentrazone-ethyl and a component B, mixed heptanoate-octanoate ester of bromoxynil. These herbicidal compositions are particularly suitable for use against Volunteer canola and weed plants in oilseed rape plants.

The present invention relates to agrochemically active herbicidal compositions and also to their use for controlling weed plants and volunteer oilseed rape, in particular volunteer Canola.

Controlling volunteer oilseed rape, in particular volunteer Canola has become a major issue in oilseed growing areas like Canada, some parts of Europe or Australia. Volunteer oilseed rape, in particular volunteer Canola is considered as a weed as it does not make a positive contribution to yield, competes with the crop for nutrients, water and light and might introduce or attract pests and disease, eg flea beetle, clubroot or blackleg. Current recommendations for controlling volunteer oilseed rape, in particular volunteer Canola include extensive rotation patterns, certain agronomic methods and herbicide use, eg bromoxynil, dicamba, florasulam, tribenuron-methyl, carfentrazone in combination with broad spectrum herbicides like glyphosate for example in pre-seeding application of herbicides. However, many of herbicides having good herbicidal efficacy they are not suitable in a pre-seeding application due to their non-residual activity (ie. prolonged activity of the herbicide in the soil after application) affecting the later crop seeded afterwards during germination and establishment.

WO 90/02120 A1 and WO 2012/126932 A1 disclose herbicidally active triazolinones, in particular carfentrazone-ethyl. Carfentrazone-ethyl having the chemical name ethyl 2-chloro-4-[2-chloro-4-fluoro-5-[4-(difluoromethyl)-4,5-dihydro-3-methyl-5-oxo-1H-1,2,4-triazol-1-yl]phenyl]propionate has been characterized as a post-emergence herbicide inhibiting protoporphrin oxidase which causes the accumulation of proto-porphyrin IX (Proto IX) that is involved in the light-dependent formation of singlet oxygen responsible for membrane peroxidation (Dayan et al, Pestic. Sci. 1997, 51, 65-73). Also compositions comprising carfentrazone-ethyl in combination with other herbicides are known.

CN102326558 describes a weeding composition containing carfentrazone-ethyl and bromoxynil octanoate characterized by comprising 1-60 percent of carfentrazone-ethyl and 1-80 percent of bromoxynil octanoate serving as active ingredients, an aid and other excipients and used for preventing and controlling broadleaf weeds and sedges.

U.S. Pat. No. 3,397,054 disclose herbicidally active 4-hydroxybenzonitriles, in particular bromoxynil chemical name: 3,5-dibromo-4-hydroxybenzonitrile). Bromoxynil is a selective contact herbicide inhibiting photosynthesis and uncoupling oxidative phosphorylation for post-emergence control or annual broad-leaved weeds. Bromoxynil is used as an ester or salt, for example as bromoxynil butyrate, bromoxynil heptanoate, bromoxynil octanoate or bromoxynil-potassium. The octanoate and heptanoate esters of Bromoxynil can be produced by esterification of the hydroxyl group of the 3,5-dibromo-4-hydroxybenzonitrile with n-octanoic acid anhydride or n-heptanoic acid anhydride according to UK1067033. Bromoxynil heptanoate possesses a melting point of 39 degree Celsius, while the melting point is bromoxynil octanoate is 45 to 46 degree Celsius and the octanoate is practically insoluble in water at 25 degree Celsius which is a disadvantage in producing liquid formulations of the active. U.S. Pat. No. 6,255,252 describes the production of the mixed ester of the octanoate and heptanoate by melting the octanoate and heptanoate ester in certain ratios. These mixtures have surprisingly having a significant lower melting point allowing easier transportation and more convenient handling and formulating of herbicidal liquid formulations.

Also compositions comprising carfentrazone-ethyl in combination with other herbicides are known. Of particular interest is a tank mix registered in Canada comprising Carfentrazone-ethyl (brand name Aim EC herbicide) and bromoxynil-octanoate (brand name Koril 235 liquid herbicide) marketed under the brand name Conquer (Nufarm) in Canada which is registered for the control of the following weeds: Kochia scoparia, Chenopodium album, Amaranthus retroflexus, Malva pusilla, Salsola kali, Salsola pestifer, Salsola australis, Salsola iberica, and Salsola tragus, Polygonum species, in particular Polygonum convolvulus and volunteer oilseed rape, in particular volunteer Canola.

However, these aforementioned practices and herbicides are not always sufficiently active against weed plants and/or volunteer oilseed rape, in particular volunteer Canola.

Accordingly, it is an object of the present invention to provide herbicidal compositions with improved properties, in particular regarding the control of certain weed species and the control of volunteer oilseed rape, in particular volunteer Canola. This object is achieved by the herbicidal compositions comprising carfentrazone-ethyl and the mixed heptanoate-octanoate ester of bromoxynil.

The present invention accordingly provides a herbicidal composition comprising
A) carfentrazone-ethyl,
B) the mixed heptanoate-octanoate ester of bromoxynil.

The herbicidal compositions may comprise or else be used together with further components, examples being active crop protection ingredients of other kinds and/or adjuvants customary in crop protection and/or formulating auxiliaries.

The herbicidal compositions surprisingly show a high activity towards controlling weed plants and/or volunteer oilseed rape, in particular volunteer Canola.

In the context of the present invention the composition comprising components A and B are present in the same formulation (co-formulation) or the composition comprising components A and B are composed from separate formulations of the single active ingredient being components A and B (tank-mix). Another example of a combination of components A and B according to the invention is that components A and B are not present together in the same formulation, but packaged separately (combipack), i.e., not jointly preformulated. As such, combipacks include one or more separate containers such as vials, cans, bottles, pouches, bags or canisters, each container containing a separate component for an agrochemical composition, here components A and B. One example is a two-component combipack. In one embodiment one or more additional component can be added eiterh to the tankmix or to the combipack. Accordingly the present invention also relates to a two-component combipack, comprising a first component which in turn comprises component A, a liquid or solid carrier and, if appropriate, at least one surfactant and/or at least one customary auxiliary, and a second component which in turn comprises component B, a liquid or solid carrier and, if appropriate, at least one surfactant and/or at least one customary auxiliary. More details, e.g. as to suitable liquid and solid carriers, surfactants and customary auxiliaries are described below.

A composition according to the invention shall mean/encompass a co-formulation, a tank mix, or a combipack.

The mixed heptanoate-octanoate ester of bromoxynil consists of bromoxynil heptanoate and bromoxynil octanoate.

In one embodiment the ratio between bromoxynil heptanoate and bromoxynil octanoate is 1:1.5 to 1.5:1, preferably 1:1.02 to 1.02 to 1, most preferably 1:1.

Volunteer oilseed rape, in particular volunteer Canola refers to oilseed rape or Canola plants growing from seeds not having germinated in the season where they were sown or being lost from oilseed rape plants during harvest in the field, one or more seasons/years later then the season in which they were seeded. These seeds enter the so called soil seed bank. Due to the capability of oilseed rape to enter second dormancy these seeds are capable of germinated in a subsequent year. They present often a changed phenotype and therefore will not contribute to yield, even if oilseed rape is again grown in such a field. Consequently volunteer oilseed rape, in particular volunteer Canola has to be considered as a weed plant and needs to be controlled. Volunteer oilseed rape comprises but is not limited to volunteer spring or winter oilseed rape, to Canola, to Canola Hybrids. Volunteer oilseed rape, in particular volunteer Canola may be tolerant to one or more of the following herbicides: glyphosate, glufosinate, imidazolines, sulfonylureas.

The term oilseed rape encompasses the economically relevant oilseed rape species Brassica napus, Brassica rapa and Brassica juncea.

In a preferred embodiment varieties of oilseed rape are characterized being spring oilseed rape or winter oilseed rape.

In a preferred embodiment varieties of oilseed rape are characterized being Canola.

“Canola” refers herein to seeds or plants of the genus Brassica (Brassica napus, Brassica rapa or Brassica juncea) from which the oil shall contain less than 2% erucic acid in its fatty acid profile and the solid component shall contain less than micromoles of any one or any mixture of 3-butenyl glucosinolate, 4-pentenyl glucosinolate, 2-hydroxy-3 butenyl glucosinolate, and 2-hydroxy-4-pentenyl glucosinolate per gram of air-dry, oil-free solid.

Canola varieties can be spring oilseed rape or winter oilseed rape.

In one aspect Brassica napus or juncea plants, plant parts or seeds are hybrid plants, plant parts or seeds . In another aspect Brassica napus or juncea hybrids are Ogura hybrids, Ms8/Rf3 hybrids (marketed under the tradename InVigor) or Ms11/Rf3 hybrids, hybrids comprising the GT73 event.

In one aspect the Canola plants, plant parts or seeds are hybrid plants, plant parts or seeds. In another aspect Canola hybrids are Ogura hybrids, Ms8/Rf3 hybrids (marketed under the tradename Invigor) or Ms11/Rf3 hybrids.

In another embodiment the Brassica napus or juncea plants, plant parts or seeds are tolerant to one or more of the herbicides selected from the group of glufosinate, glyphosate (tradename RoundupReady), imazamethabenz, imazamethabenz-methyl, imazamox, imazamox-ammonium, imazapic, imazapic-ammonium, imazapyr, imazapyr-isopropyl-ammonium, imazaquin, imazaquin-ammonium, imazethapyr, imazethapyr-ammonium, atrazine, simazine, tribenuron-methyl, thifensulfuron methyl.

In another embodiment the Canola plants, plant parts or seeds are tolerant to one or more of the herbicides selected from the group of glufosinate (tradename Liberty), glyphosate (tradename RoundupReady), imazamethabenz, imazamethabenz-methyl, imazamox, imazamox-ammonium, imazapic, imazapic-ammonium, imazapyr, imazapyr-isopropyl-ammonium, imazaquin, imazaquin-ammonium, imazethapyr, imazethapyr-ammonium, atrazine, simazine, tribenuron-methyl, thifensulfuron methyl.

In another embodiment the Canola seeds show an altered oil profile within the Canola oil, in particular a higher amount of oleic acid.

In another embodiment the Canola plants, plant parts or seeds are transgenic and comprise one or more following transgenic events:

Event BLR1 (oilseed rape, restoration of male sterility, deposited as NCIMB 41193, described in WO 2005/074671), Event MON88302 (oilseed rape, herbicide tolerance, deposited as PTA-10955, described in WO 2011/153186), Event MS11 (oilseed rape, pollination control—herbicide tolerance, deposited as ATCC PTA-850 or PTA-2485, described in WO 01/031042); Event MS8 (oilseed rape, pollination control—herbicide tolerance, deposited as ATCC PTA-730, described in WO 01/041558 or US-A 2003-188347); Event RF3 (oilseed rape, pollination control—herbicide tolerance, deposited as ATCC PTA-730, described in WO 01/041558 or US-A 2003-188347); Event RT73 (oilseed rape, herbicide tolerance, not deposited, described in WO 02/036831 or US-A 2008-070260); event MON-88302-9 (oilseed rape, herbicide tolerance, ATCC Accession No PTA-10955, WO 2011/153186A1), event DP-061061-7 (oilseed rape, herbicide tolerance, no deposit No available, WO 2012071039A1), event DP-073496-4 (oilseed rape, herbicide tolerance, no deposit No available, US2012131692).

In another embodiment the Canola plants, plant parts or seeds are transgenic and comprise the Ms8/RF3 event and the GT73 event. In another embodiment the Canola plants, plant parts or seeds are transgenic and comprise the Ms8/RF3 event and the MON-88302-9 event.

Oilseed rape plants or seeds, in particular Canola plants and seeds are marketed under the following brandnames: InVigor (Bayer CropScience), Clearfield (BASF), Nexera (Dow), Optimum Gly (Dupont), ClearValley (Cargill), TruFlex (Monsanto).

Pre-seeding application is defined as the application of active ingredients in a field before seeding the crop to be grown in that field in that year. Seeding of the actual crop takes place typically 2 to 5 days after applying the pre-seeding herbicides.

“control of weed plants or volunteer oilseed rape” means a reduction in occurrence of of weed plants or volunteer oilseed rape in a certain area, compared with an untreated area, measured as % efficacy, an efficacy of 25-50%, compared with the untreated area (0% of weeds or volunteer oilseed rape controlled), more preferably an efficacy of 40-79%, compared with the untreated area (0% of weeds or volunteer oilseed rape controlled); even more preferably, the weeds or volunteer oilseed rape is entirely suppressed (an efficacy of 70-100%). The level of control is assessed regarding the degree of damage (eg deformation, necrosis), stunting or death or a combination thereof.

The herbicidal compositions can be applied in a manner known to the skilled person, as for example together (for example as a co-formulation or as a tank mix) or else a short time after one another (splitting), for example to the plants, plant parts or plant seeds or to the area on which the plants are growing. Possible, for example, is the application of the individual active ingredients or of the herbicidal compositions in two, three or more portions (sequential application), for example after pre-emergence applications. Preference here is given to joint or near-synchronous application of components A, B.

In one embodiment the herbicidal composition according to the invention is applied as a pre-seeding application, preferably as a pre-seeding application before seeding oilseed rape.

In one embodiment the herbicidal composition according to the invention is applied as a pre-seeding application, preferably as a pre-seeding application before seeding Canola.

In the herbicidal compositions of the invention, the application rate of component A) carfentrazone-ethyl is 2 to 50 g of active ingredient (a. i.) per hectare, preferably 5 to 30 g a. i./ha, especially preferably 7.5 to 25 g a. i./ha. Very preferred are the application rates for component A) carfentrazone-ethyl of 9 g/ha and 18 g/ha.

The application rate of component B) a mixed heptanoate-octanoate ester of bromoxynil is 50 to 400 g of active ingredient (a. i.) per hectare, preferably 75 to 350 g a. i./ha, especially preferably 100 to 300 g a. i./ha. Very preferred are the application rates for component B) a mixed heptanoate-octanoate ester of bromoxynil of 140 g/ha and 280 g/ha.

At certain concentration ratios, the effect of the herbicidal compositions on weed plants and volunteer oilseed rape is particularly pronounced. The weight ratios of components A, B can be varied within certain ranges. Generally speaking, there are 1: 50 to 1:1 parts by weight, preferably 1:20 to 1:1 parts by weight, especially preferably 1:8 to 1:1 of component A per part by weight of component B.

When the herbicidal compositions of the invention are used, a very broad spectrum of weed plants are controlled pre-emergence and post-emergence, examples being annual and perennial monocotyledonous or dicotyledonous weeds, and also unwanted crop plants. The herbicidal compositions of the invention are particularly suitable for use in oilseed rape varieties, in particular Canola hybrids, very particularly spring Canola hybrids.

The present invention accordingly further provides a method for controlling weed plants in oilseed rape varieties, in particular Canola hybrids, very particularly spring Canola hybrids that is characterized in that components A and B of the herbicidal compositions of the invention are applied to the plants (e.g. weed plants such as dicotyledonous weeds or unwanted crop plants like volunteer oilseed rape) or to the area on which the plants are growing, such application taking place jointly or separately, for example.

Dicotyledonous weeds come, for example, from the genera Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus, Taraxacum, Euphorbia.

In one embodiment herbicidal compositions are described for the use of controlling weed plants selected from Echinochloa crusgalli (barnyard grass), Lappula squarrosa (bluebur), Cirsium arvense (Canadian thistle), Stellaria media (chickweed), Galium aparine (cleavers), Vaccaria hispanica (cow cockle), Taraxacum officinale (dandelion), Equisetum arvense (field horsetail), Descurainia sophia (flixweed), Setaria viridis (green foxtail), Polygonum scabrum (green smartweed), Galeopsis tetrahit (hemp nettle), Kochia scoparia, Chenopodium album (lamb's-quarters), Crepis tectorum (narrow leaf hawksbeard), Amaranthus retroflexus (redroot pigweed), Salsola pestifer (Russian thistle), Capsella bursa-pastoris (shepherd's-purse), Sonchus sp. (sow thistle), stinkweed, Erodium cicutarium (stork's bill), Polygonum convolvulus (wild buckwheat), Sinapis arvensis (wild mustard), Avena fatua (wild oats), wild rose.

In one embodiment herbicidal compositions are described for the use of controlling weed plants selected from Taraxacum officinale (dandelion), Kochia scoparia, Chenopodium album (lamb's-quarters), Crepis tectorum (narrow leaf hawksbeard), Chenopodium album (lamb's-quarters), Amaranthus retroflexus (redroot pigweed), Polygonum convolvulus (wild buckwheat), Sinapis arvensis (wild mustard), volunteer oilseed rape, in particular volunteer Canola.

In one embodiment herbicidal compositions are described for the use of controlling weed plants selected from volunteer oilseed rape, in particular volunteer Canola.

The invention also provides for the use of the herbicidal compositions of the invention for controlling weed plant growth in oilseed rape varieties, in particular Canola hybrids, very particularly spring Canola hybrids.

The herbicidal compositions of the invention can be produced by known methods, for example as mixed formulations of the individual components, optionally with further active ingredients, adjuvants and/or customary formulation assistants, these compositions being then employed in a customary way as dilutions with water, or may be produced in the form of what are called tank mixes, by joint dilution of the separately formulated or partially separately formulated individual components with water. Likewise possible is the temporally offset application (split application) of the separately formulated or partially separately formulated individual components. Another possibility is the application of the individual components or of the herbicidal compositions in two or more portions (sequential application), as for example after applications pre-emergence, followed by post-emergence applications, or after early post-emergence applications, followed by applications in the middle or late post-emergence phase. Preference here is given to the joint or near-synchronous application of the active ingredients of the respective combination.

The herbicidal compositions of the invention can also be used for controlling weed plants in crops of genetically modified oilseed rape varieties, in particular Canola hybrids, very particularly spring Canola hybrids.

In general, transgenic plants are notable for special advantageous properties, for example for resistances to certain pesticides, in particular certain herbicides, resistances to plant diseases or organisms that cause plant diseases, such as certain insects or microorganisms such as fungi, bacteria or viruses. Other special properties relate, for example, to the harvested material with regard to quantity, quality, storability, composition and specific constituents. For instance, there are known transgenic plants with an elevated starch content or altered starch quality, or with a different fatty acid composition in the harvested material. Other special properties may be tolerance or resistance to abiotic stressors, for example heat, low temperatures, drought, salinity and ultraviolet radiation.

On employment of the compositions of the invention in transgenic crops, the effects toward weed plants observed in other crops are often also accompanied by effects which are specific to application in the particular transgenic crop, for example an altered or specifically widened spectrum of weeds which can be controlled, altered application rates which can be used for the application, preferably good combinability with the herbicides to which the transgenic crop is resistant, and influencing of growth and yield of the transgenic crop plants.

The invention therefore also provides for the use of the compositions of the invention for controlling weed plants in transgenic crop plants.

Preference is given to the use of the compositions of the invention in economically important transgenic oilseed rape varieties, in particular Canola hybrids, very particularly spring Canola hybrids

In another embodiment the use of the compositions of the invention is described on oilseed rape plants, plant parts or seeds being tolerant to one or more of the herbicides selected from the group of glufosinate (tradename Liberty), glyphosate (tradename RoundupReady), imazamethabenz, imazamethabenz-methyl, imazamox, imazamox-ammonium, imazapic, imazapic-ammonium, imazapyr, imazapyr-isopropyl-ammonium, imazaquin, imazaquin-ammonium, imazethapyr, imazethapyr-ammonium, atrazine, simazine, tribenuron-methyl, thifensulfuron methyl.

In another embodiment the use of the compositions of the invention is described on Canola plants, plant parts or seeds being tolerant to one or more of the herbicides selected from the group of glufosinate (tradename Liberty), glyphosate (tradename RoundupReady), imazamethabenz, imazamethabenz-methyl, imazamox, imazamox-ammonium, imazapic, imazapic-ammonium, imazapyr, imazapyr-isopropyl-ammonium, imazaquin, imazaquin-ammonium, imazethapyr, imazethapyr-ammonium, atrazine, simazine, tribenuron-methyl, thifensulfuron methyl.

The invention therefore also provides for the use of the compositions of the invention for controlling weed plants in transgenic oilseed rape plants or oilseed rape plants having tolerance through selective breeding.

The components A and B can be converted together or separately into customary formulations, for example for application by spraying, watering and sprinkling, such as solutions, emulsions, suspensions, powders, foams, pastes, granules, aerosols, active ingredient-impregnated natural and synthetic substances, and microencapsulations in polymeric substances. The formulations may comprise the customary auxiliaries and adjuvants.

These formulations are produced in a known manner, for example by mixing the components A and B with extenders, i.e. liquid solvents, pressurized liquefied gases and/or solid carriers, optionally with use of surfactants, i.e. emulsifiers and/or dispersants and/or foam formers.

If the extender used is water, it is also possible to use, for example, organic solvents as auxiliary solvents. Useful liquid solvents are essentially: aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example petroleum fractions, mineral and vegetable oils, alcohols, such as butanol or glycol and the ethers and esters thereof, ketones, such as acetone, methyl ethyl ketone, methyl isobutyl ketone or cyclohexanone, strongly polar solvents, such as dimethylformamide or dimethyl sulphoxide, and water.

Useful solid carriers include: for example ammonium salts and ground natural minerals, such as kaolins, clays, talc, chalk, quartz, attapulgite, montmorillonite or diatomaceous earth, and ground synthetic minerals, such as finely divided silica, alumina and silicates; useful solid carriers for granules include: for example crushed and fractionated natural rocks, such as calcite, marble, pumice, sepiolite, dolomite and synthetic granules of inorganic and organic flours, and granules of organic material, such as sawdust, coconut shells, maize cobs and tobacco stalks; useful emulsifiers and/or foam formers include: for example nonionic and anionic emulsifiers, such as polyoxyethylene fatty acid esters, polyoxyethylene fatty alcohol ethers, e.g. alkylaryl polyglycol ethers, alkylsulphonates, alkyl sulphates, arylsulphonates and protein hydrolysates; useful dispersants include: for example lignosulphite waste liquors and methylcellulose.

In the formulations, it is possible to use tackifiers such as carboxymethylcellulose, natural and synthetic polymers in the form of powders, granules or latices, such as gum arabic, polyvinyl alcohol and polyvinyl acetate, or else natural phospholipids such as cephalins and lecithins and synthetic phospholipids. Further additives may be mineral and vegetable oils.

It is possible to use colorants such as inorganic pigments, for example iron oxide, titanium oxide and Prussian Blue, and organic dyes, such as alizarin dyes, azo dyes and metal phthalocyanine dyes, and trace nutrients such as salts of iron, manganese, boron, copper, cobalt, molybdenum and zinc.

The formulations contain generally between 0.1 and 95 per cent by weight of components A and B, preferably between 0.5 and 90% by weight.

As such or in their formulations, the components A and B can also be used as a mixture with other agrochemically active ingredients for controlling unwanted plant growth, for example for controlling weeds or for controlling unwanted crop plants, in particular volunteer oilseed rape or volunteer Canola; finished formulations or tank mixes, for example, are possible.

Also possible are mixtures with other known active ingredients such as fungicides, insecticides, acaricides, nematicides, bird antifeedants, plant nutrients and soil improvers, and likewise with adjuvants and formulation assistants customary in crop protection.

In one embodiment mixtures or tank-mixes with the following herbicides selected from the group comprising glyphosate and salts thereof or glufosinate and salts thereof are described.

Glyphosate can be used as an ester or a salt. Examples are glyphosate-diammonium [Cas-No 69254-40-6], glyphosate-dimethylammonium [Cas-No 34494-04-7], glyphosate-isopropylammonium [Cas-No 38641-94-0], glyphosate-monoammonium [Cas-No 40465-66-5], glyphosate-potassium [Cas-No 39600-42-5], glyphosate-sesquisodium [Cas-No 70393-85-0], glyphosate-trimesium [Cas-No 81591-81-3]. In one embodiment the potassium salt or ammomium salt is used.

In another embodiment mixtures or tank-mixes with glyphosate or salts thereof and components A and B or salts thereof are described.

In another embodiment mixtures or tank-mixes with glyphosate and components A and B or salts thereof are described, wherein glyphosate is present as a potassium or ammonium salt or both.

Glyphosate or salts thereof may be added at concentration between 200 and 1000 g/ha, preferably 300 to 900 g/ha.

The weight ratios of components A, B and Glyphosate or salts thereof can be varied within certain ranges. Generally speaking, there are 1:50:50 to 1:1:1 parts by weight, preferably 1:20:40 to 1:1:1 parts by weight, especially preferably 1:8:20 to 1:1: of component A per part by weight of component B per part by weight of glyphosate or salts thereof.

The components A and B can be used as such, in the form of their formulations or the use forms prepared therefrom by further dilution, such as ready-to-use solutions, suspensions, emulsions, powders, pastes and granules. Application is typically accomplished, for example, by watering, sprinkling, spraying, broadcasting. In one embodiment Application is accomplished by watering, sprinkling, spraying, broadcasting prior to crop establishment.

The components A and B can be deployed on the plants, plant parts or the area under cultivation (farmland), preferably on the green plants and plant parts, and on the farmland. One means of application is the co-deployment of the active ingredients in the form of tank mixes, by mixing the optimally formulated concentrated formulations of the individual active ingredients together in the tank with water and deploying the spray liquor obtained.

For application, the formulations present in commercial form are optionally diluted in a customary manner, for example using water in the case of wettable powders, emulsifiable concentrates, dispersions and water-dispersible granules. Preparations in the form of dusts, granules for soil application or granules for broadcasting and sprayable solutions are usually not diluted further with other inert substances prior to application.

The formulations comprising the composition according to the invention may be applied in the field at temperatures between 5 and 30 degree Celsius at a relative humidity of 40% to 90%.

The following examples are meant to illustrate the present invention and are not limiting

### BIOLOGICAL EXAMPLES

### Example 1

Field tests at eight locations in Western Canada were conducted to evaluate the efficacy of the mixture comprising component A, carfentrazone-ethyl and component B, mixed heptanoate-octanoate ester of bromoxynil for control of weeds and volunteer Canola on target weed and volunteer Canola in May or June before any crop establishment. The volunteer Canola was glyphosate tolerant. AIM (600 g/L carfentrazone-ethyl, EC formulation, FMC) was applied together with Pardner (280 g/l mixed heptanoate-octanoate ester of bromoxynil, EC formulation, Bayer CropScience) and Roundup Weathermax as a broadcast foliar spray. Cleanstart (a tank mix comprising AIM together with Credit comprising glyphosate (as a mixed potassiumand ammomium salt) at a concentration of 356 g/l solution) together with Roundup Weathermax, Roundup Weathermax (potassium salt solution of glyphosate at a concentration of 356 g/l solution Pardner (as a single treatment and Conquer (Tank mix of AIM together with Koril 235 Liquid herbicide comprising bromoxynil-octonoate (Nufarm) together with Roundup Weathermax were applied for comparison in neighbouring plots. The volunteer Canola which was controlled was tolerant to glyphosate, which is indicated by the low amount of volunteer Canola controlled by Roundup Weathermax alone. After the application of the herbicides the plots were either seeded with Canola (crop control) about 3 days after herbicide application or left unseeded (bare ground). Evaluation took place after between 13 to 29 days after application of the herbicides.

The efficacy is expressed as % efficacy according to the calculation of Abbott (W.S Abbott, Journal of the American Mosquito Control Association (1987), Vol 3, 2, 302-303) wherein 0% efficacy represents an untreated control and 100% efficacy represents that 100% of weed plants or volunteer Canola are controlled. The results are shown in Tables 1 to 4:

TABLE 1
Efficacy against volunteer Canola tolerant
to glyphosate (crop control)

| | | Test Location No | | | |
|---|---|---|---|---|---|
| | | 1 | 2 | 3 | 4 |
| | | Evaluation time | | | |
| | | [days after application] | | | |
| | | 14 | 13 | 17 | 14 |
| Product | | % effi- | % effi- | % effi- | % effi- |
| tested | Dosage [g/ha] | cacy | cacy | cacy | cacy |
| Cleanstart | 9 (cpd A) + 450 | 75 | 66.7 | | 88.7 |
| | (glyphosate) | | | | |
| Roundup | 540 (glyphosate) | 0 | 1.7 | 0 | 0 |
| Weathermax | | | | | |
| Pardner + | 140 (cpd A) + 540 | 85 | 80 | 30 | 84.3 |
| Roundup | (glyphosate) | | | | |
| Weathermax | | | | | |
| Pardner + | 280 (cpd A) + 540 | 86.7 | 90 | — | 89.3 |
| Roundup | (glyphosate) | | | | |
| Weathermax | | | | | |
| Conquer + | 9 (cpd A) + 140 | 78.3 | 91.7 | 88 | 93.3 |
| Roundup | (bromoxynil | | | | |
| Weathermax | octanoate) + 540 | | | | |
| | (glyphosate) | | | | |
| Aim + | 9 (cpd A) + 140 | 80 | 95 | 90 | 94 |
| Pardner + | (cpd B) + 540 | | | | |
| Roundup | (glyphosate) | | | | |
| Weathermax | | | | | |
| Aim + | 18 (cpd A) + 140 | 91.7 | 94 | 82.5 | 95 |
| Pardner + | (cpd B) + 540 | | | | |
| Roundup | (glyphosate) | | | | |
| Weathermax | | | | | |
| Aim + | 9 (cpd A) + | 95 | 92.3 | 91.7 | 96.3 |
| Pardner + | 280 (cpd B) + | | | | |
| Roundup | 540 (glyphosate) | | | | |
| Weathermax | | | | | |

TABLE 2
Efficacy against volunteer Canola tolerant
to glyphosate (crop control)

| | | Test Location No | | | |
|---|---|---|---|---|---|
| | | 1 | 2 | 3 | 4 |
| | | Evaluation time | | | |
| | | [days after application] | | | |
| | | 21 | 20 | 24 | 21 |
| Product | | % effi- | % effi- | % effi- | % effi- |
| tested | Dosage [g/ha] | cacy | cacy | cacy | cacy |
| Cleanstart | 9 (cpd A) + 450 | 85 | 74 | 50 | 84.3 |
| | (glyphosate) | | | | |
| Roundup | 540 (glyphosate) | 0 | 1.7 | 0 | 0 |
| Weathermax | | | | | |
| Pardner + | 140 (cpd A) + 540 | 93 | 93 | 30 | 78.3 |
| Roundup | (glyphosate) | | | | |
| Weathermax | | | | | |
| Pardner + | 280 (cpd A) + 540 | 99 | 92.5 | 87.5 | 87 |
| Roundup | (glyphosate) | | | | |
| Weathermax | | | | | |
| Conquer + | 9 (cpd A) + 140 | 94.3 | 99 | 88 | 89.3 |
| Roundup | (bromoxynil | | | | |
| Weathermax | octanoate) + 540 | | | | |
| | (glyphosate) | | | | |
| Aim + | 9 (cpd A) + 140 | 97.7 | 99 | 90 | 92.7 |
| Pardner + | (cpd B) + 540 | | | | |
| Roundup | (glyphosate) | | | | |
| Weathermax | | | | | |
| Aim + | 18 (cpd A) + 140 | 99 | 95.3 | 82.5 | 90 |
| Pardner + | (cpd B) + 540 | | | | |
| Roundup | (glyphosate) | | | | |
| Weathermax | | | | | |
| Aim + | 9 (cpd A) + | 99 | 96.7 | 91.7 | 91.7 |
| Pardner + | 280 (cpd B) + | | | | |
| Roundup | 540 (glyphosate) | | | | |
| Weathermax | | | | | |

TABLE 3
Efficacy against volunteer Canola tolerant to glyphosate (bare ground)

| | | Test Location No | | | | | | | |
|---|---|---|---|---|---|---|---|---|---|
| | | 5 | 6 | 1 | 7 | 8 | 4 | 3 | 2 |
| | | Evaluation time [days after application] | | | | | | | |
| | | 13 | 15 | 14 | 14 | 14 | 14 | 17 | 13 |
| Product tested | Dosage [g/ha] | % efficacy | % efficacy | % efficacy | % efficacy | % efficacy | % efficacy | % efficacy | % efficacy |
| Cleanstart | 9 (cpd A) + | 53.3 | 87.7 | 75 | 23.3 | 47.3 | 88.7 | 56.7 | 66.7 |
| | 450 (glyphosate) | | | | | | | | |
| Roundup | 540 (glyphosate) | 6.7 | 0 | 0 | 23.3 | 0 | 0 | 0 | 1.7 |
| Weathermax | | | | | | | | | |
| Pardner + | 140 (cpd A) + | 99.3 | 46.7 | 85 | 76.7 | 85.7 | 83 | 30 | 80 |
| Roundup | 540 (glyphosate) | | | | | | | | |
| Weathermax | | | | | | | | | |
| Pardner + | 280 (cpd A) + | 100 | 85 | 86.7 | 90 | 91.7 | 89.3 | 85 | 90 |
| Roundup | 540 (glyphosate) | | | | | | | | |
| Weathermax | | | | | | | | | |
| Conquer + | 9 (cpd A) + | 100 | 97 | 78.3 | 53.3 | 76.7 | 93.3 | 87 | 91.7 |
| Roundup | 140 (bromoxynil | | | | | | | | |
| Weathermax | octanoate) + | | | | | | | | |
| | 540 (glyphosate) | | | | | | | | |
| Aim + | 9 (cpd A) + | 100 | 97 | 80 | 88.3 | 85.7 | 94 | 85 | 95 |
| Pardner + | 140 (cpd B) + | | | | | | | | |
| Roundup | 540 (glyphosate) | | | | | | | | |
| Weathermax | | | | | | | | | |
| Aim + | 18 (cpd A) + | 96 | 97 | 91.7 | 91.7 | 87 | 95 | 84 | 94 |
| Pardner + | 140 (cpd B) + | | | | | | | | |
| Roundup | 540 (glyphosate) | | | | | | | | |
| Weathermax | | | | | | | | | |
| Aim + | 9 (cpd A) + | 100 | 97 | 95 | 94.7 | 91.7 | 96.3 | 91.7 | 92.3 |
| Pardner + | 280 (cpd B) + | | | | | | | | |
| Roundup | 540 (glyphosate) | | | | | | | | |
| Weathermax | | | | | | | | | |

TABLE 4
Efficacy against volunteer Canola tolerant to glyphosate (bare ground)

| | | Test Location No | | | | | | | |
|---|---|---|---|---|---|---|---|---|---|
| | | 5 | 6 | 1 | 7 | 8 | 4 | 3 | 2 |
| | | Evaluation time [days after application] | | | | | | | |
| | | 29 | 21 | 21 | 21 | 21 | 21 | 24 | 20 |
| Product tested | Dosage [g/ha] | % efficacy | % efficacy | % efficacy | % efficacy | % efficacy | % efficacy | % efficacy | % efficacy |
| Cleanstart | 9 (cpd A) + | 61.7 | 85 | 85 | 53.3 | 59 | 84.3 | 50 | 74 |
| | 450 (glyphosate) | | | | | | | | |
| Roundup | 540 (glyphosate) | 0 | 0 | 0 | 16.7 | 4.7 | 0 | 0 | 1.7 |
| Weathermax | | | | | | | | | |
| Pardner + | 140 (cpd A) + | 92.3 | 43.3 | 93 | 86.7 | 99 | 78.3 | 30 | 93 |
| Roundup | 540 (glyphosate) | | | | | | | | |
| Weathermax | | | | | | | | | |
| Pardner + | 280 (cpd A) + | 100 | 86 | 99 | 93.3 | 97.7 | 87 | 82.5 | 92.5 |
| Roundup | 540 (glyphosate) | | | | | | | | |
| Weathermax | | | | | | | | | |
| Conquer + | 9 (cpd A) + | 97 | 97.3 | 94.3 | 81.7 | 78.7 | 89.3 | 87 | 99 |
| Roundup | 140 (bromoxynil | | | | | | | | |
| Weathermax | octanoate) + | | | | | | | | |
| | 540 (glyphosate) | | | | | | | | |
| Aim + | 9 (cpd A) + | 95 | 96.3 | 97.7 | 90 | 95 | 92.7 | 85 | 99 |
| Pardner + | 140 (cpd B) + | | | | | | | | |
| Roundup | 540 (glyphosate) | | | | | | | | |
| Weathermax | | | | | | | | | |
| Aim + | 18 (cpd A) + | 90.7 | 98 | 99 | 88.3 | 94.7 | 90 | 84 | 95.3 |
| Pardner + | 140 (cpd B) + | | | | | | | | |
| Roundup | 540 (glyphosate) | | | | | | | | |
| Weathermax | | | | | | | | | |
| Aim + | 9 (cpd A) + | 97.7 | 97 | 99 | 88.3 | 99 | 91.7 | 91.7 | 96.7 |
| Pardner + | 280 (cpd B) + | | | | | | | | |
| Roundup | 540 (glyphosate) | | | | | | | | |
| Weathermax | | | | | | | | | |

1. Herbicidal composition comprising
a component A, carfentrazone-ethyl and
a component B, mixed heptanoate-octanoate ester of bromoxynil.

2. Herbicidal composition according to claim 1, comprising component A and component B in a weight ratio of 1:50 to 50:1.

3. Herbicidal composition according to claim 1, comprising component A and component B in a weight ratio of 1:50 to 6:1.

4. Herbicidal composition according to claim 1, comprising component A and component B in a weight ratio of 1:37.5 to 2:1.

5. Herbicidal composition according to claim 1, comprising in addition glyphosate or a salt thereof.

6. Method for controlling volunteer Canola or weed plants in one or more crops of oilseed rape plants, comprising applying a herbicidal composition according to claim 1 to the volunteer Canola and/or weed plants, oilseed rape plants, oilseed plant parts, or oilseed plant seeds and/or to an area on which the volunteer Canola and/or weed plants grow.

7. Method according to claim 6, wherein the oilseed rape plants, plant parts or seeds are from the group consisting of Brassica napus, Brassica rapa and Brassica juncea.

8. Method according to claim 6, wherein the oilseed rape plants, plant parts or seeds are Canola plants, plant parts or seeds.

9. Method according to claim 6 wherein the oilseed rape plant is tolerant to one or more of the herbicides selected from the group of glufosinate (tradename Liberty), glyphosate (tradename RoundupReady), imazamethabenz, imazamethabenz-methyl, imazamox, imazamox-ammonium, imazapic, imazapic-ammonium, imazapyr, imazapyr-isopropyl-ammonium, imazaquin, imazaquin-ammonium, imazethapyr, imazethapyr-ammonium, atrazine, simazine tribenuron-methyl, thifensulfuron methyl.

10. Method according to claim 6, wherein it that is carried out in a pre-seed application.

11. Method according to claim 6, that is carried out for controlling volunteer Canola plants.

12. Method according to claim 6, wherein component A is used at an application rate of 5 to 200 g and component B at an application rate of 25 to 750 g per hectare.

13. A herbicidal composition according to claim 1 for controlling volunteer Canola or weed plants in one or more crops of oilseed rape plants, plant parts or seeds.

14. A composition according to claim 13, wherein the oilseed rape plants, plant parts or seeds are Canola plants, plant parts or seeds.

15. A composition according to claim 13 for controlling Canola volunteer plants.
